(19) United States
(12) Patent Application Publication
(10) Pub. No.: US 2006/0236327 A1
(43) Pub. Date: Oct. 19, 2006

(54) GUI-based API for test systems

(75) Inventor: Ziyang Lu, Camas, WA (US)

Correspondence Address: WAGNER, MURABITO & HAO, LLP, TWO NORTH MARKET STREET, THIRD FLOOR, SAN JOSE, CA, 95113, US

(73) Assignee: Credence Systems Corporation

(21) Appl. No.: 11/108,018

(22) Filed: Apr. 14, 2005

(51) Int. Cl. G06F 9/44; G06F 3/00

(52) U.S. Cl. 719/328

(57) ABSTRACT

A GUI-based API for a test system provides a user-friendly interface for generating API function calls in one of several different programming languages, as selected by the user. The GUI-based API prompts the user to select from a list of valid API functions, which are generated based on the test system configuration. The values for the selected API function parameters are then specified by selecting from a valid list of choices or by entering an arbitrary value. The valid list of choices presented to the user for selection is generated based on the test system configuration and on the prior parameter values specified by the user. For API functions including parameters that have a main parameter and optional parameters, input interfaces for specifying the values for the optional parameters are also presented to the user. Every parameter of the selected API function is processed, so that when the last parameter is processed, an appropriate end of function signature is automatically inserted.

### BACKGROUND OF THE INVENTION

1. Field of the Invention

The present invention generally relates to application programming interfaces (APIs) and, more particularly, to methods for generating test system API function calls using a graphical user interface (GUI).

2. Description of the Related Art

A user of a test system, when testing a semiconductor device in the test system, needs to provide test data and specify operating instructions to the test system. The user does this by writing a test program that calls API functions provided by the test system software. The API is usually presented to the user in the same programming language as the test system software, e.g., C, C++, or Java. The API also inherits the programming style and data structures of the test system software. Therefore, the API is often quite complex, considering the challenging tasks the test system software needs to handle.

To make test systems more user-friendly, test system vendors typically provide a GUI, with which the user can view and edit test data to run and debug tests interactively. Because of the high-level of abstraction, the GUI is often quicker to learn and easier to use. In particular, design engineers rely heavily on the GUI provided by engineering validation test systems. For first silicon debug or device failure analysis, an easy-to-use interactive environment is helpful for the design engineer to engage in a “what-if” analysis by changing operating conditions and observing the effects in real time. However, as device complexity has increased, the GUI alone may no longer be sufficient. Often, the device response shown in the GUI is transferred into the design simulation environment for interpretation. For such tasks, knowledge of API programming is required.

The Vanguard™ test system, manufactured and sold by Credence Systems Corporation, provides a GUI with which design engineers, who are not proficient in API programming, can select and customize API function calls. Details of the GUI-based API implemented in the Vanguard™ test system is provided in the document authored by Ziyang Lu, entitled “GUI Based Tester API for the Vanguard Tester,” the entire contents of which are incorporated by reference herein.

### SUMMARY OF THE INVENTION

Embodiments of the present invention improve on the GUI-based API implemented in the Vanguard™ test system, and are applicable to any type of test system or tester platform. The GUI-based API according to embodiments of the present invention provides one or more of the following additional features: dynamic implementation, adjusted context, optional parameters, complete implementation, and multiple languages.

Dynamic implementation. The API information to be presented to the user for selection, e.g., available API functions and available test system resources, is generated at runtime based on the actual test system configuration. This feature is useful in test system architectures that have plug-and-play capabilities, such as the Sapphire® test system manufactured and sold by Credence System Corporation, because the configurations of such test systems can easily change and are often different depending on the device being tested.

Adjusted context. The context of an API function is adjusted as parameter values are selected by the user, so that when the user is selecting values for other parameters of the same API function, the parameter values that are not applicable to the adjusted context are not presented to the user for selection.

Optional parameters. Some API functions include parameters that have a main parameter and optional parameters. For such API functions, input interfaces for specifying the values for the optional parameters are presented to the user.

Complete implementation. Every parameter of an API function is processed, so that when the last parameter is processed, an appropriate end of function signature can be inserted automatically.

Multiple languages. API programming code can be generated in one of several different programming languages, such as Perl, Python, Verilog, VHDL, and Matlab, as selected by the user.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a test system in which the GUI-based API according to an embodiment of the present invention may be used;

FIG. 2 is a block diagram depicting some of the software components of the GUI-based API according to an embodiment of the present invention;

FIG. 3 is a flow diagram illustrating the steps carried out by the GUI-based API according to an embodiment of the present invention;

FIGS. 4A and 4B are sample GUIs showing how the user can select a particular API programming language;

FIGS. 5A-E are sample GUIs that are presented to the user during composition of an API function call;

FIG. 6 is a sample GUI showing the levels window with which a user may read or write pin level settings;

FIGS. 7A and 7B are sample GUIs showing how the list of available API functions differ for differently configured test systems;

FIG. 8 is a sample GUI showing the test system resources that have been made available for selection based on the configuration of the test system;

FIGS. 9A-D are sample GUIs showing how the selection of a particular pin levels setting determines what pins are made available for selection;

FIGS. 10A-C are sample GUIs showing how the selection of a pattern type determines what input fields are activated for inputs;

FIGS. 11A-C are sample GUIs showing input interfaces for a main parameter and optional parameters; and

FIG. 12 illustrates the API function call generated based on the values specified for the optional parameters.

### DETAILED DESCRIPTION

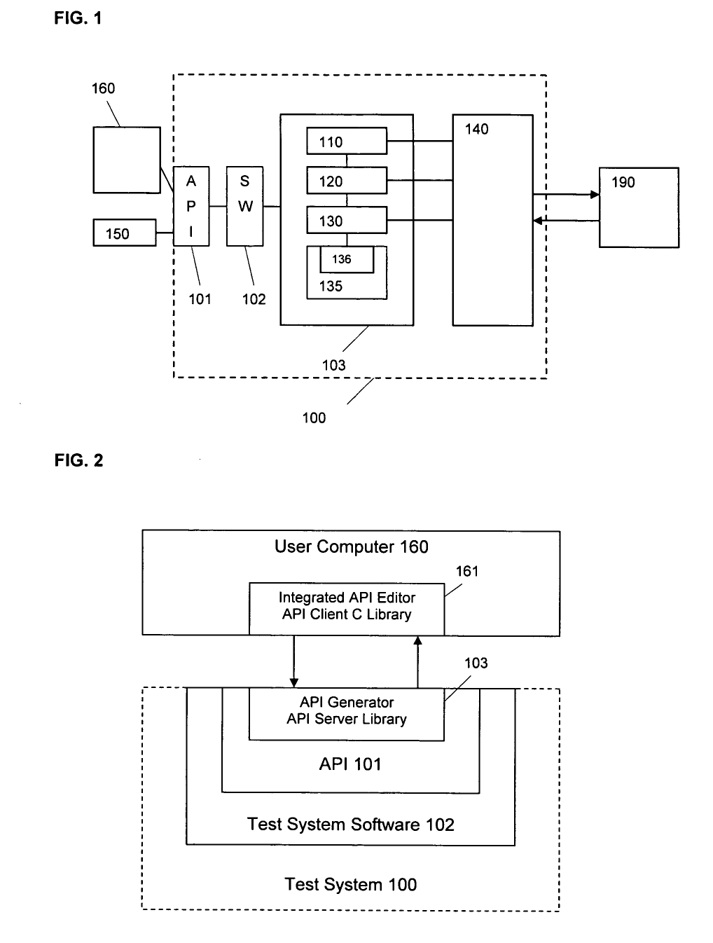

FIG. 1 illustrates a test system in which the GUI-based API according to an embodiment of the present invention may be implemented. The test system 100 includes a number of slots in which a number of test instruments are inserted. The instruments include a device power supply (DPS) 110 for supplying power to a device under test (DUT) 190, analog test instruments 120 for supplying test signals to input analog pins of the DUT 190 and receiving response signals from output analog pins of the DUT 190, digital test instruments 130 for supplying test signals to input digital pins of the DUT 190 and receiving response signals from output digital pins of the DUT 190, a test head interface 135 which houses a master clock 136, and a fixture 140, known in the art as a loadboard, for providing a connection interface between the instruments 110, 120, 130 and the DUT 190. During testing, the test system 100 operates under the control of software module 102. The software module 102 includes a plurality of software components that is interfaced to an application program 150 through an API 101. A user computer 160 is also interfaced to the API. The user computer 160 includes conventional components of a computer, including a processing unit, memory, and input and output devices such as a keyboard, mouse, and a display.

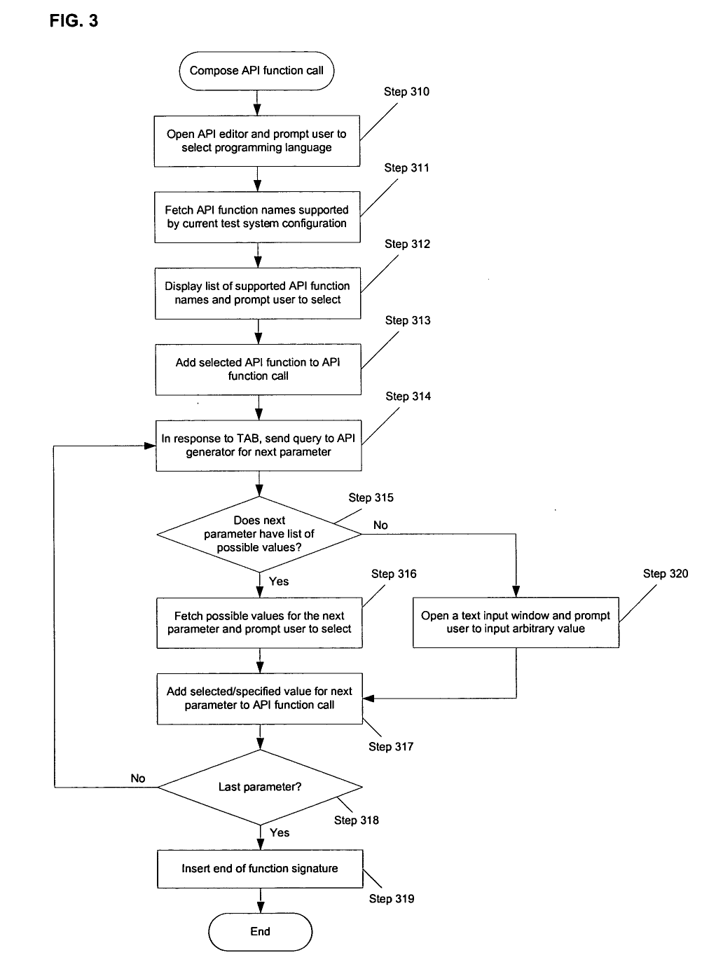

As shown in FIG. 2, the GUI-based API includes a client process 161 running on the user computer 160 and a server process 103 running as part of the test system 100. The two processes communicate through network sockets. The client process 161 includes a thin client library that is implemented in C and is used for design environment integration. The client C library is implemented in a portable fashion so that API programs can run on different computing platforms. The server process 103 includes a heavy server library that handles the API function calls and is implemented in the same way as the test system API 101 and the test system software 102. Because the server library resides inside the test system 100, data processing is efficient, and communication overhead is kept at a minimum.

The client C library makes the API available in multiple languages by linking the C library with the target language's executable. Once linked, the API functions can be called in the target language's native format. This approach can be applied to all languages capable of C extensions including the ones shown in Table 1.

TABLE 1

| Language Name | Extension Name | Language Description |
|---|---|---|
| Perl | C Extension | Scripting |
| Python | C Extension | Scripting |
| Verilog | PLI | Design implementation |
| VHDL | FLI | Design implementation |
| Matlab | MEX | Technical computing |

The GUI-based API maps certain test system API functions that are part of the API 101 to GUI elements including windows, spreadsheets, and dialogs. Table 2 below shows the mapping of the more commonly used test system API functions.

TABLE 2

| GUI Element | API Function | Description |
|---|---|---|
| Levels window | get_levels | Read/write pin level settings |
| | set_levels | |
| Timing window | get_timing | Read/write pin timing settings |
| | set_timing | |
| Pattern window | get_pattern | Read/write pattern data |
| | set_pattern | |
| Start/stop button | test_control | Start/stop a test |

The GUI-based API employs a code generator, LiteGen [source info], to produce much of the low-level details of the code. For each API function, LiteGen would read its declaration and generate: (i) code to handle client-server messaging; (ii) code to add glue logic for embedding the API in various languages; and (iii) code to interface with the test system software. Using LiteGen frees up time and resources to ensure the quality of the GUI-based API implementation. For example, dynamic type checking may be implemented, such that, at run time every function parameter is verified before the test system software performs the required operation.

The GUI-based API also includes an integrated, interactive API editor, using which the user can generate API function calls. The API editor is implemented as part of the client process 161 and functions like a typical text editor, except that it is connected to the test system 100. While the user is typing, the API editor communicates with the test system 100, in particular the API generator, to fetch relevant API information, e.g., available API functions and/or available test system resources, which in turn is presented to the user in pop-up lists or dialogs. The API generator is implemented as part of the server process 103 to accept queries from the API editor. For each query, the API generator will check the states and/or configuration of the test system 100, and generate responses to the query (e.g., find and transmit available API functions and/or available test system resources).

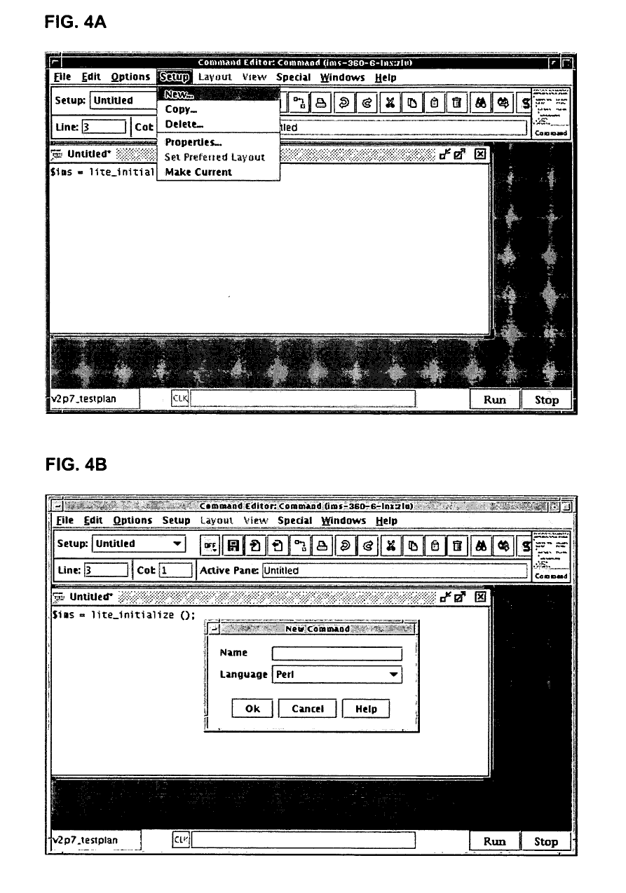

FIG. 3 is a flow diagram illustrating the steps carried out by the GUI-based API when a user is employing the API editor to compose an API function call. In the example given below, the user is making a call to the API function, set_levels, to change the “VIL” level of the “BusA” pin to 1.8 volts. In Step 310, when the API editor is first opened (see FIG. 4A), the user is prompted to select a programming language (see FIG. 4B). Perl is set as the default language, but the user may change the language selection to one of other programming languages, e.g., Python. After a programming language is selected, the API editor presents a reference variable, $ims, for the user to make the API function calls.

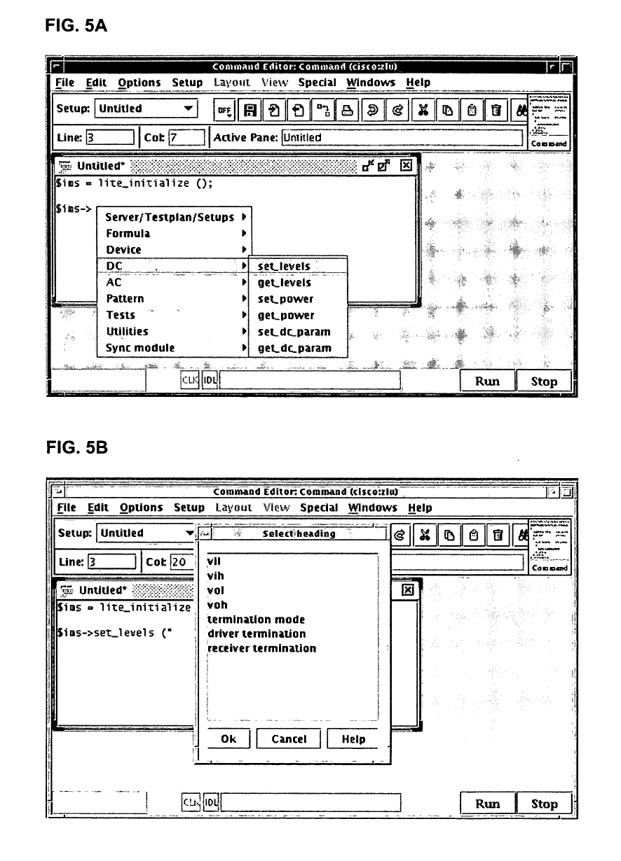

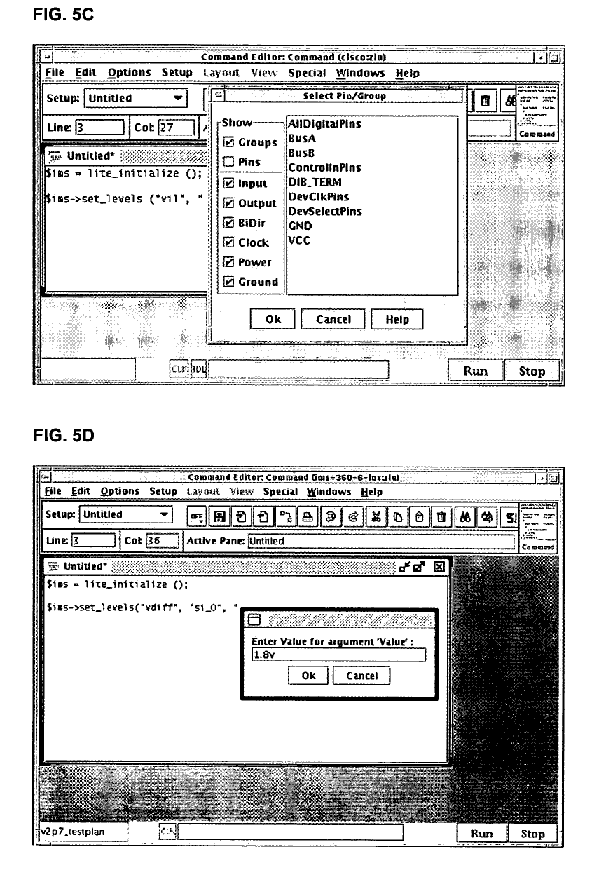

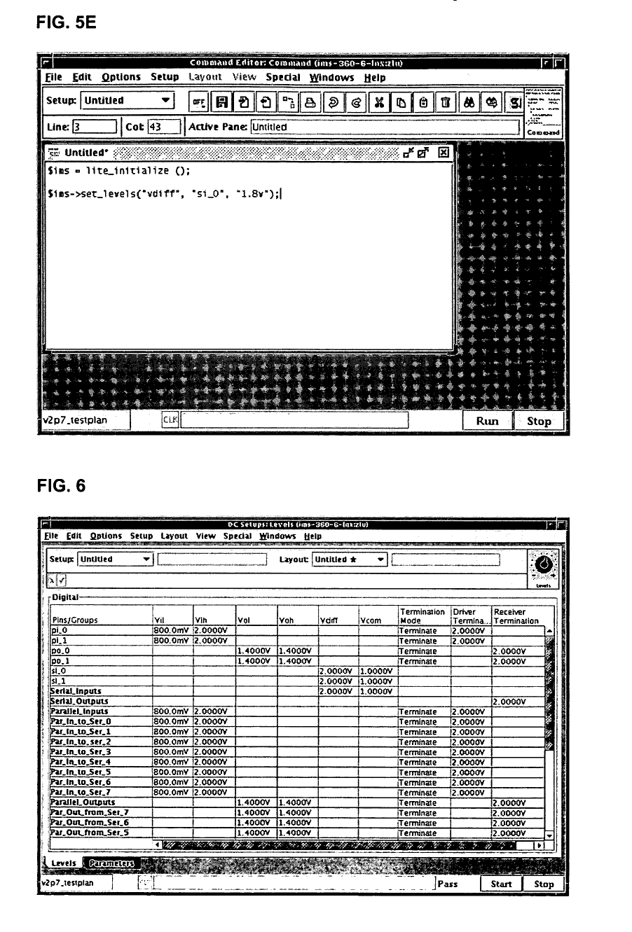

When the user types in $ims→, the API editor, which is keeping track of the typing, sends a query to the API generator to fetch all the API function names supported by the current test system configuration (Step 311), and pops up a list for the user to choose from (Step 312). A sample list is illustrated in FIG. 5A. To change a levels setting for a pin, the user selects the API function, set_levels. In Step 313, the API editor adds the selected API function to the text, so the API function call now looks like:
$ims→set_levels (

The user then presses the TAB key. The API editor understands from the TAB key input that the user is about to set a value for the first parameter, so its sends a query to the API generator for the next parameter (Step 314). The API generator knows that the first parameter of the API function set_levels, has a list of possible values associated therewith (Step 315), so it fetches the list of possible values and transmits the list to the API editor, which prompts the user to select from one of the values (Step 316). The list is illustrated in FIG. 5B. The user selects VIL. In Step 317, the API editor adds the selected value to the text, so the API function call now looks like:
$ims→set_levels (“vil”.

The GUI-based API processes each and every parameter of the API functions that it supports. Therefore, the GUI-based API is able to determine when the API function call is complete (Step 318), and automatically inserts an end of function signature when all parameters of the function have been defined (Step 319). If the last parameter has not been processed and the user presses the TAB key again, the API editor understands from the TAB key input that the user is about to set a value for the next parameter, so its sends a query to the API generator for the next parameter (return to Step 314). The API generator determines that the next (second) parameter of the API function, set_levels, has to be a DUT pin/group name (Step 315), so it fetches a list of all DUT pin/group names available in the current test system configuration to which the selected first parameter value (VIL) is applicable and transmits the list to the API editor, which prompts the user to select from one of the values (Step 316). The list is illustrated in FIG. 5C. From the list, the user selects BusA. In Step 317, the selected value is added to the text, so the API function call now looks like:
$ims→set_levels (“vil”, “BusA”,

The API generator knows that the API function, set_levels, has three parameters and so the process flow continues on to Step 314. When the user presses the TAB key again, the API editor understands from the TAB key input that the user is about to set a value for the next parameter, so its sends a query to the API generator for the next parameter (Step 314). The API generator determines that no information is available for the next (third) parameter (Step 315) and communicates this to the API editor. In response, the API editor pops up a text input window prompting the user to input a value for the next parameter (Step 320). The text input window is illustrated in FIG. 5D. The user types in “1.8 v” and clicks on the OK button. In Step 317, the API editor adds the value entered into the text input window to the API function call, so the API function call now looks like:
$ims→set_levels (“vil”, “BusA”, “1.8 v”

Values for all three parameters of the API function, set_levels, have now been defined (Step 318), and so the API editor inserts the end of function signature automatically (for Perl, the character string ‘);’ indicates end of function) to complete the generation of the API function call (Step 319). FIG. 5E illustrates the completed API function call.

The GUI-based API processes each parameter of a selected API function the following way. For parameters with a list of valid choices, it will present the list to the user for selection. For parameters of arbitrary value, it will pop up a text input window for user input. As a consequence, the API editor turns API programming into an interactive process with context sensitive help. This eliminates the need for extensive training. Moreover, the API editor performs API queries automatically without user intervention.

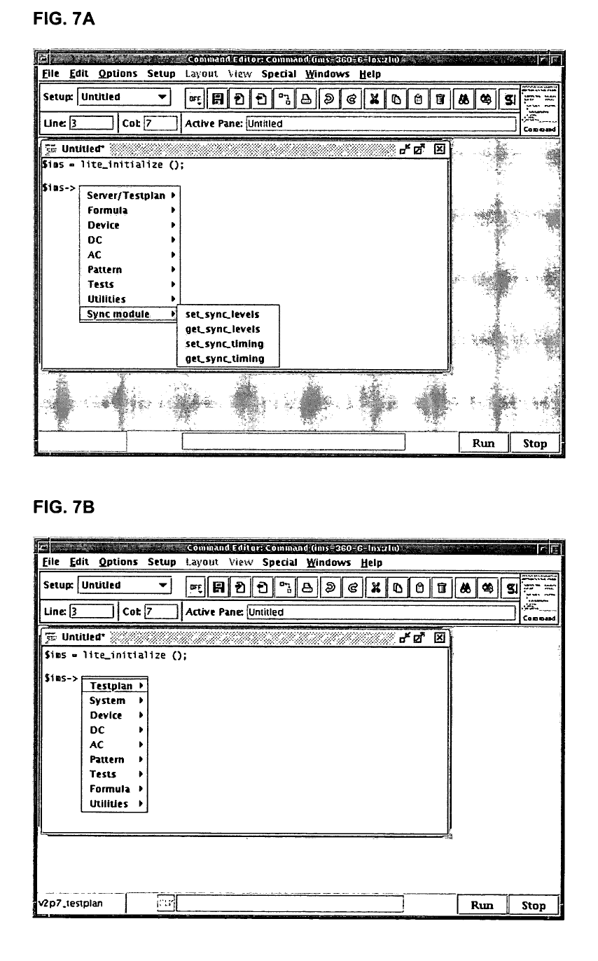

The GUI-based API is also dynamic and so it generates certain API information at runtime based on the actual test system configuration. As a result, API functions that are not supported by the current test system configuration are not presented to the user. FIG. 7A shows the list of API functions made available for selection when the test system has a “Sync” module plugged in. FIG. 7B shows the list of API functions made available for selection when the test system does not have a “Sync” module plugged in. This feature is useful in test system architectures that have plug-and-play capabilities, such as the Sapphire® test system, because its configuration can easily change and is often different depending on the device being tested.

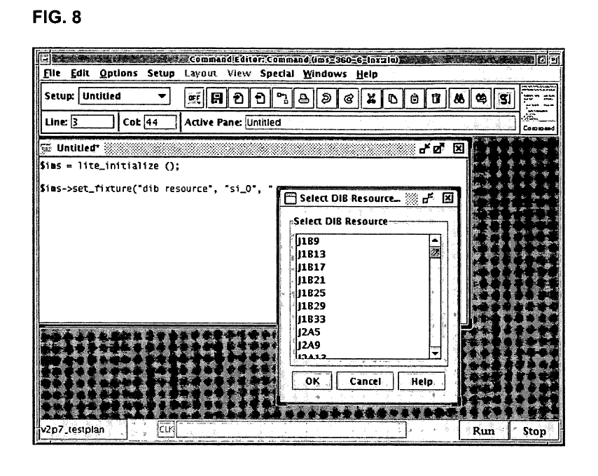

In addition, the GUI-based API checks the test system configuration for available test system resources and communicates a list of supported test system resources back to the user. For example, to connect a device pin to a test system channel on the DIB (Device Interface Board), the user would use the set_fixture function. When this function is accessed, the GUI-based API checks the module locations in the test system, and communicates a list of valid (supported) DIB resources to the user, as shown in FIG. 8.

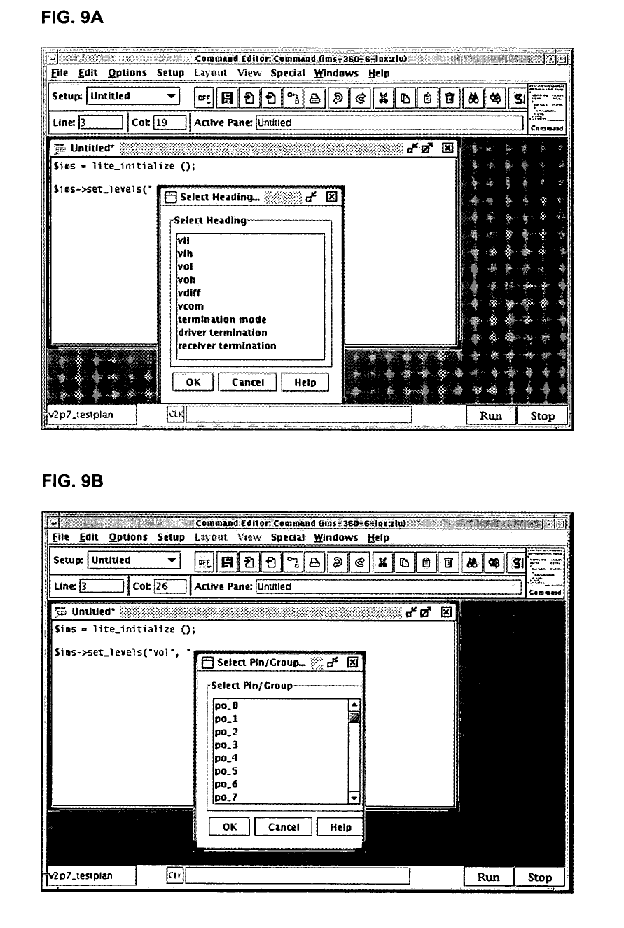

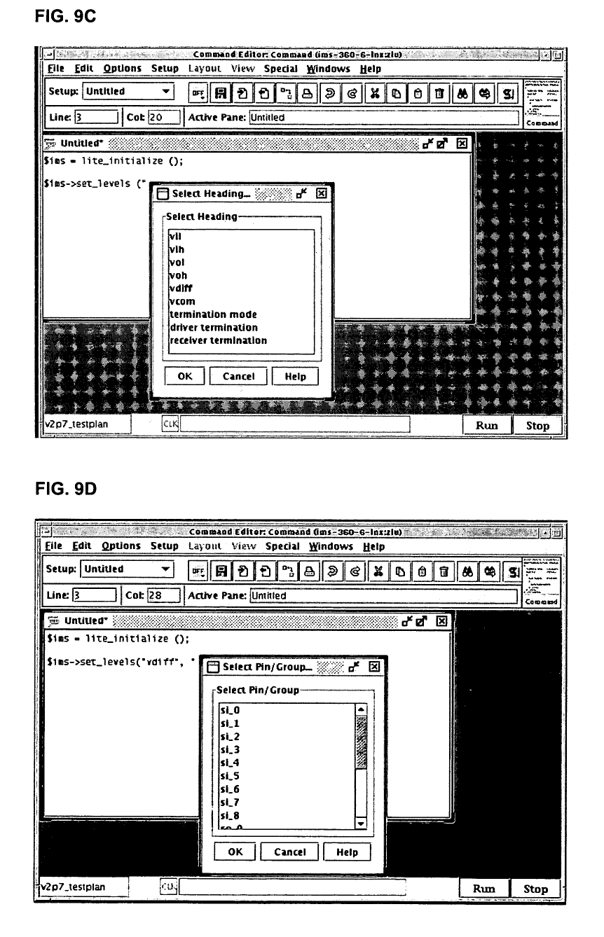

The GUI-based API is also able to dynamically adjust the context of the API function as the parameter values are being set and present a list of valid parameter value choices based on the dynamically adjusted context. FIGS. 9A-D provide two examples. In FIG. 9A, the user specifies the first parameter of the API function, set_levels, to be VOL. As shown in the “Levels” window (FIG. 6), VOL settings can only be set for output single-ended pins, and so only the output single-ended pins appear in the list of valid parameter value choices when the user is prompted to select the value for the second parameter of the set_levels function (see FIG. 9B). In FIG. 9C, the user specifies the first parameter of the API function, set_levels, to be VDIFF. As shown in the “Levels” window (FIG. 6), VDIFF settings can only be set for differential pins, and so only the differential pins appear in the list of valid parameter value choices when the user is prompted to select the value for the second parameter of the set_levels function (see FIG. 9D).

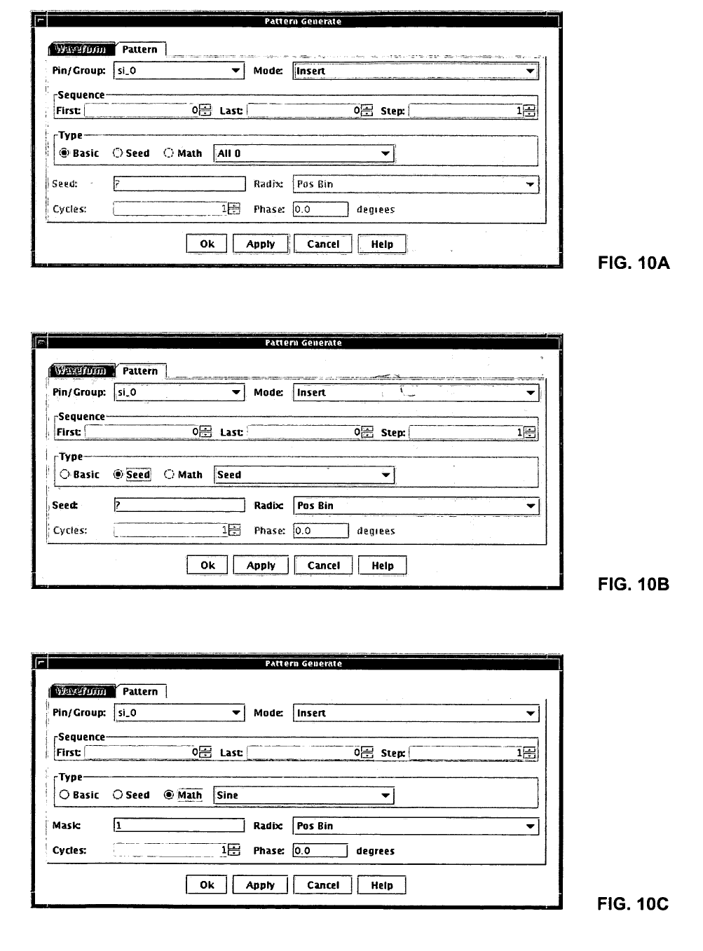

FIGS. 10A-C illustrate an input interface for the API function, pattern_generate, and provide another example of dynamically adjusted context. In FIG. 10A, the user specifies “Basic” as the pattern type, which is one of the parameters required by the API function, pattern_generate. In FIG. 10B, the user specifies “Seed” as the pattern type. In FIG. 10C, the user specifies “Math” as the pattern type. In response to these selections, the context of the API function is adjusted so that different input fields are activated and deactivated. The deactivated input regions are grayed out in FIGS. 10A-C. For example, the “Cycles” and “Phase Degree” input fields are activated only for the “Math” type. They are grayed out for the other types.

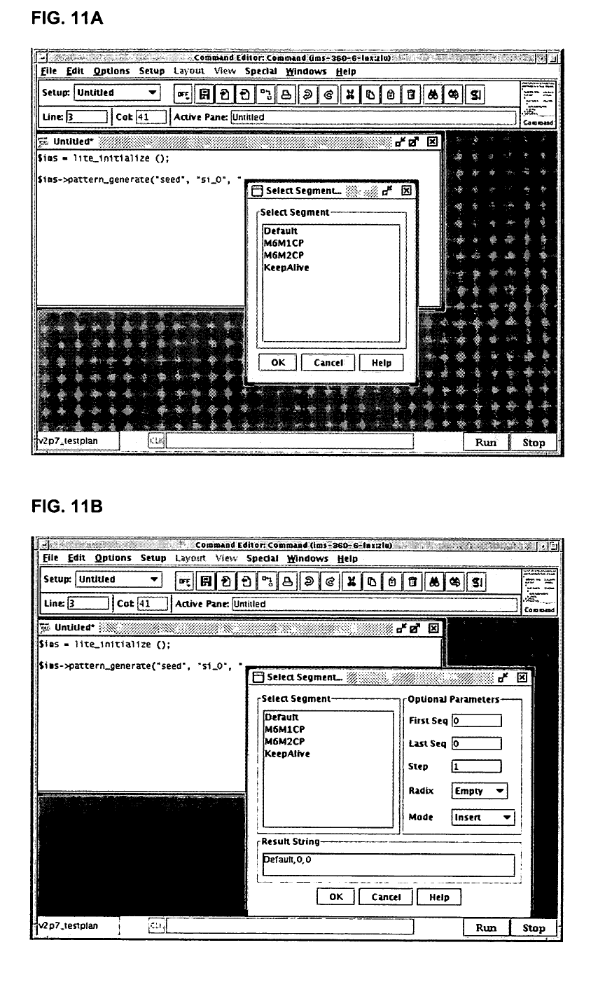

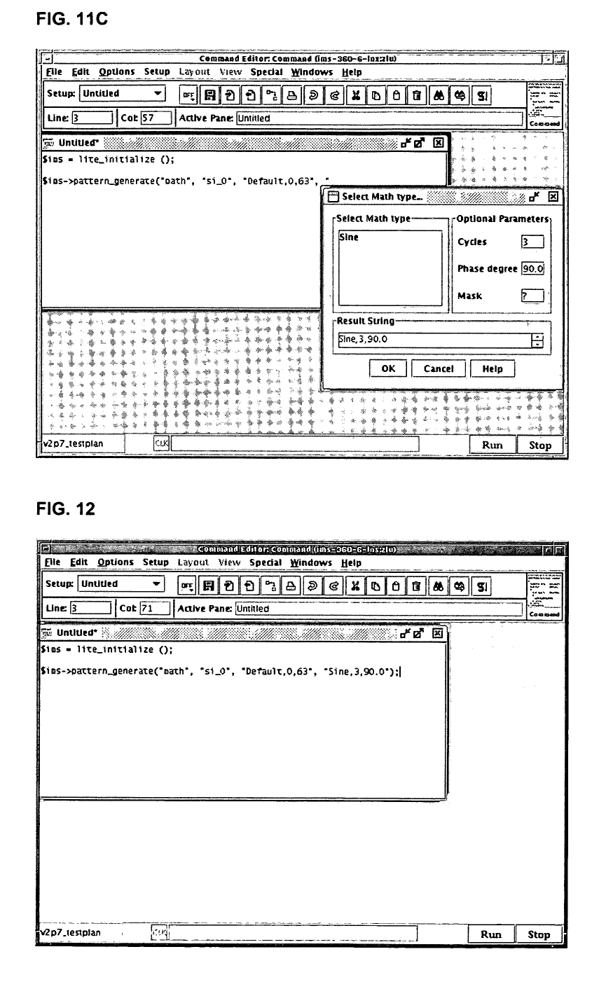

Some API functions, such as pattern_generate, include parameters that have a main parameter and optional parameters. The GUI-based API provides input interfaces for specifying the values for both the main parameter and the optional parameters. For example, for the API function, pattern_generate (type, pin, range, subtype), when the user specifies “Seed” as the pattern type, the GUI-based API provides a list of pattern segments to be selected as the value for the main parameter, “range,” as shown in FIG. 11A. Once the user selects a pattern segment, the GUI-based API provides an input interface for specifying the values of appropriate optional parameters. The optional parameters for a “Seed” type pattern segment are shown in FIG. 11B. The optional parameters for a “Math” type pattern segment are shown in FIG. 11C. The user inputs for the optional parameters are placed into the function call as shown in FIG. 12.

In an alternative embodiment of the present invention, the API function, set_levels, can also be called using the “Levels” window shown in FIG. 6. To change the VOL setting for pin “po_{—}0” to 1.8 v, the user would simply open the “Levels” window, click the cell with column “VOL” and row “po_{—}0”, and type string “1.8 v” into the cell. Further, when the “Levels” window is opened by the user, the API function, get_levels, is called a multiple number of times, and the voltages levels of the pins are retrieved from the test system and displayed in corresponding cells appearing in the “Levels” window.

While the foregoing is directed to embodiments of the present invention, other and further embodiments of the invention may be devised without departing from the basic scope thereof, and the scope thereof is determined by the claims that follow.

What is claimed is:

1. A method of generating API function calls to be executed in a test system, comprising the steps of:
identifying API functions that are available based on a configuration of the test system;
presenting a group of the available API functions for selection; and
generating an API function call based on a selected API function.

2. The method according to claim 1, further comprising the steps of:
identifying system resources that are available based on the configuration of the test system; and
presenting a group of the available system resources for selection,
wherein the API function call is generated based on the selected API function and a selected system resource.

3. The method according to claim 1, further comprising the steps of:
presenting a group of parameter values, one of which is to be selected as a parameter value for a parameter of the selected API function; and
presenting a plurality of input fields,
wherein one or more of the input fields are deactivated in response to the selection of the parameter value.

4. The method according to claim 3, further comprising the step of presenting an input interface for use in specifying additional parameters relevant to said parameter of the selected API function.

5. The method according to claim 1, further comprising the steps of:
presenting a first group of parameters values, one of which is to be selected as a parameter value for a first parameter of the selected API function; and
presenting a second group of parameters values, one of which is to be selected as a parameter value for a second parameter of the selected API function,
wherein the second group of parameter values is determined based on the parameter value selected for the first parameter.

6. The method according to claim 1, further comprising the step of presenting a group of programming languages for selection, wherein the API function call is generated in a programming language as selected.

7. The method according to claim 1, wherein the step of generating the API function call comprises the steps of:
retrieving a group of parameters for the API function call;
determining values for each of the parameters; and
when the values have been determined for all of the parameters, generating a character string that indicates an end of the API function call.

8. The method according to claim 7, wherein the values for each of the parameters are determined based on inputs made through a graphical user interface.

9. A method of generating API function calls to be executed in a test system, comprising the steps of:
presenting a group of the supported API functions for selection;
retrieving a group of parameters for a selected API function; and
generating the API function call based on the selected API function, including data for each of the parameters and a character string that indicates an end of the API function call.

10. The method according to claim 9, wherein the data for each of the parameters are generated based on inputs made through a graphical user interface.

11. The method according to claim 10, further comprising the step of presenting a group of programming languages for selection, wherein the API function call is generated in a programming language as selected.

12. The method according to claim 9, wherein the step of generating the API function call comprises the step of presenting a graphical user interface for making inputs relating to at least one of the parameters, wherein data for said at least one of the parameters are generated based on said inputs.

13. The method according to claim 12, wherein the graphical user interface presents a group of valid choices for selection for at least one of the parameters.

14. The method according to claim 12, wherein the graphical user interface includes an input field in which an arbitrary string of characters can be specified for at least one of the parameters.

15. The method according to claim 9, wherein the step of generating the API function call comprises the step of presenting a series of input interfaces for the parameters, wherein the data for each of the parameters are generated based on inputs made using the input interfaces.

16. The method according to claim 15, wherein the parameters are ordered in accordance with a sequence predefined for the selected API function, and the input interfaces for the parameters are presented in accordance with said sequence.

17. The method according to claim 16, wherein the character string that indicates the end of the API function call is generated when an input using the last input interface in the series of input interfaces is confirmed.

18. A computer-readable medium having stored therein program instructions to be executed in an apparatus for controlling a system operable under software control to carry out the steps of:
identifying API functions and system resources that are supported by the system;
presenting a group of the supported API functions and a group of supported system resources for selection; and
generating the API function call based on a selected API function and a selected system resource, including a character string that indicates an end of the API function call.

19. The computer-readable medium according to claim 18, further including program instructions to be executed in the apparatus for controlling a system operable under software control to carry out the additional steps of:
retrieving a group of parameters for the selected API function; and
determining values for each of the parameters,
wherein the character string that indicates the end of the API function call is generated after values for all of the parameters have been determined.

20. The computer-readable medium according to claim 18, further including program instructions to be executed in the apparatus for controlling a system operable under software control to carry out the additional step of presenting a group of programming languages for selection, wherein the API function call is generated based on a selected programming language.
